(19) United States
(12) Patent Application Publication
(10) Pub. No.: US 2009/0068621 A1
(43) Pub. Date: Mar. 12, 2009

(54) PAPER CUTTING ACTIVITY KIT

(75) Inventor: Toni M. Schulken, Charlotte, NC (US)

Correspondence Address: THOMPSON HINE L.L.P.;Intellectual Property Group, P.O. BOX 8801, DAYTON, OH, 45401-8801, US

(73) Assignee: MEADWESTVACO CORPORATION, Glenn Allen, VA (US)

(21) Appl. No.: 11/852,392

(22) Filed: Sep. 10, 2007

(51) Int. Cl. G09B 19/00

(52) U.S. Cl. 434/82

(57) ABSTRACT

An activity kit including an assembly sheet with a drawing provided thereon and a strip of color paper. The kit further includes instructions instructing a user to cut the strip of color paper into smaller pieces and adhere the cut pieces onto the drawing.

The present invention is directed to an activity kit, and more particularly, to a paper cutting activity kit including cutting paper and an assembly sheet.

### BACKGROUND

Preschool children and others learning to develop fine motor skills and the like may utilize various guides, activities or the like to aid in their development. Such guides, tools activities or the like may help to develop the user's writing instrument control skills, visual motor control skills, fine motor control skills, visual perception skills and bilateral coordination skills. The development of these skills helps to advance and improve the user's snipping, cutting, pasting, writing and drawing skills.

### SUMMARY

In one embodiment, the present invention is an activity kit including an assembly sheet with a drawing provided thereon and a strip of color paper. The kit further includes instructions instructing a user to cut the strip of color paper into smaller pieces and adhere the cut pieces onto the drawing.

### BRIEF DESCRIPTION OF THE DRAWINGS

FIG. 1 is a top view of one embodiment of the kit of the present invention;

FIG. 2 is a top view of the kit of FIG. 1, with the strips of color paper being cut into squares and part of the drawing being peeled away;

FIG. 3 is a top view of the kit of FIG. 2, with the cut pieces of color paper adhered onto the drawing;

FIG. 4 illustrates another completed assembly, shown in conjunction with the strips of color paper used to form the completed assembly;

FIG. 5 is a top view of the assembly sheet of another embodiment of the invention;

FIG. 6 illustrates a cutting sheet that may be used in combination with the assembly sheet of FIG. 5;

FIG. 7 is a top view of the assembly sheet of FIG. 5, which a cut piece adhered thereto and a peelable portion being removed therefrom;

FIG. 8 illustrates an assembly sheet of another embodiment of the invention;

FIG. 9 is a top view of a cutting sheet that may be used in combination with the assembly sheet of FIG. 8;

FIG. 10 is a top view of an assembly sheet of another embodiment of the invention;

FIG. 11 is a top view of a cutting sheet that may be used in combination with the assembly sheet of FIG. 10;

FIG. 12 illustrates another embodiment of the kit of the present invention;

FIG. 13 illustrates the kit of FIG. 12, with the various portions cut into separate pieces;

FIG. 14 illustrates the pieces of FIG. 13, assembled together;

FIG. 15 is a top view of another embodiment of the kit of the present invention;

FIG. 16 is a top view of the kit of FIG. 15, shown in an assembled condition;

FIG. 17 is a top view of another embodiment of the kit of the present invention;

FIG. 18 is a top view of the kit of FIG. 17, shown in an assembled condition;

FIG. 19 is a top view of another embodiment of the kit of the present invention; and

FIG. 20 is a top view of the kit of FIG. 12, shown in an assembled condition.

### DETAILED DESCRIPTION

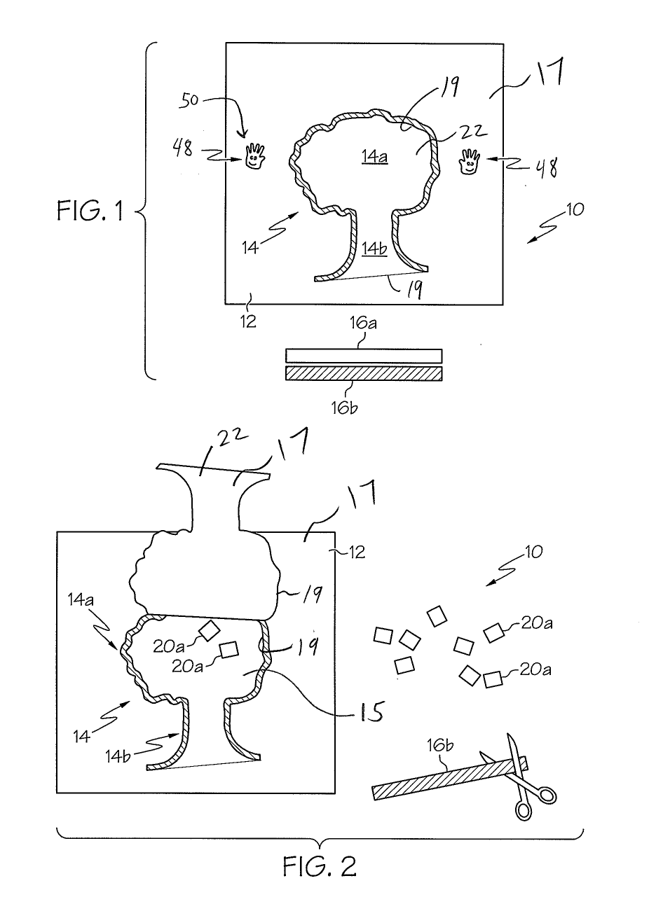

As shown in FIG. 1, one embodiment of the activity kit 10 of the present invention includes a drawing sheet or assembly sheet 12 with a drawing 14 provided thereon, and a strip of color paper 16 (two strips 16a, 16b are included in the embodiment of FIG. 1). The drawing 14 can take any of a variety of recognizable objects or shapes, such as animals, flowers, objects, designs, people, etc. The assembly sheet 12 can be made from any of a wide variety of materials, but will typically be made of a cellulose-based or pulp-based paper such that the assembly sheet 12 is generally water absorbent and can be written upon a wide variety of media (i.e., pens, pencils, markers, crayons etc.) The assembly sheet 12 may be relatively thin, and may have a thickness of about 0.5 mm or less.

The strips of color paper 16 may be made of the same materials as the assembly sheet 12 described above, and may be rectangular and relatively elongate. Each strip 16 may initially be presented as part of a larger sheet which needs to be cut out (i.e. by a user, or the user's parents or teachers, etc.) to result in the strips 16 shown in FIGS. 1 and 2. In this case each strip 16 may have a line extending therearound and presenting a border about which a user can cut to release each strip 16. Alternately each strip 16 may be initially presented in the “strip” form shown in FIGS. 1 and 2.

Each strip 16 may have a width (i.e. extending in the vertical direction of FIG. 1) that is less than about 1½ inches to allow a typical child user to snip the strip 16 (i.e. cut with a single scissors stroke) across its width. In a more specific embodiment each strip 16 may have a length that is at least about 10 times its width to allow easy snipping of said strip 16 into smaller pieces. Moreover, each strip of color paper 16 may have a length that is about equal to an outer dimension of the assembly sheet 12. For example, if the assembly sheet 12 has dimensions of about 9 inches×12 inches, each strip of color paper 16 may have dimensions of about ½ inch×9 inches. The use of a common dimension between the sheets 12 and strips 16 can aid in ease of manufacturing.

The drawing 14 may have a plurality of discrete portions, which can be portions that are commonly recognized as different parts or portions thereof, parts which have differing common names, parts which have differing shape or natural boundary, etc. For example, in the embodiment of FIG. 1, the drawing of the tree 14 includes a leaf portion 14a and a trunk portion 14b. Each strip of color paper 16 may be made of a color that corresponds to the typical color of one of the discrete portions of the drawing 14. For example, the strip of color paper 16a may be green (corresponding to the leaf portion 14a of the tree) and the strip of color paper 16b may be brown (corresponding to the trunk portion 14b).

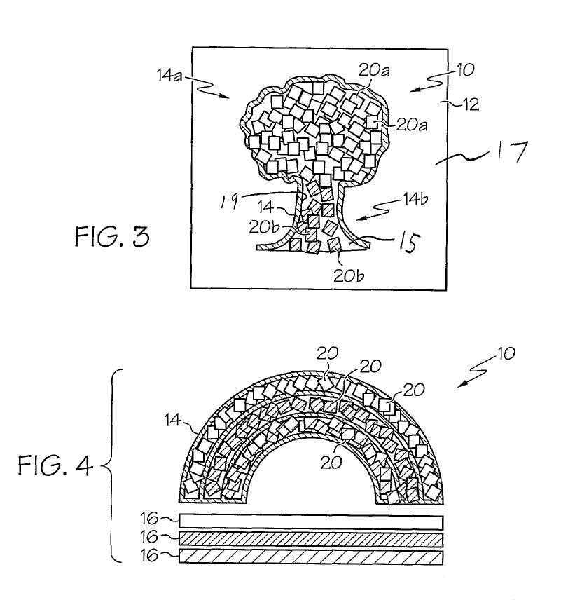

In order to utilize the kit 10, a user first snips the strips of color paper 16 into smaller pieces. In one embodiment, the strips of color paper 16 are snipped/cut into generally square pieces 20, as shown in FIGS. 2 and 3, although the strips of color paper 16 can be cut into rectangles or other shapes. The elongate size of the strips of color paper 16 allow them to be easily snipped. The strips of color paper 16 can be snipped into squares having side lengths equal to the width of the strips 16 by making a single snip per square, as schematically shown in FIG. 2. For relatively young users, the use of safety scissors is recommended. This snipping step helps to develop scissor skills and bilateral coordination of the user, and also develops isolated functioning of the two sides of a hand.

Once the strips 16 are cut into smaller pieces 20, the cut pieces 20 can be adhered to the drawing 14, and more particularly, can be adhered in/to the corresponding drawing portions. Continuing with the example of FIGS. 1 and 2, the green pieces 20a from strip 16a can be adhered to the leaf portion 14a of the tree, and the brown pieces 20b from strip 16b can be adhered to the trunk portion 14b. After (or before) the cut pieces 20 are adhered, the remainder of the drawing 14/sheet 12 can be colored or otherwise decorated, if desired.

The drawing 14 may be defined by printed lines or the like which are relatively thick (i.e. in one embodiment having a thickness of at least about ⅛ inch, or between about ⅛ inch and about ¼ inch thick). The thick nature of the lines allows some of the cut pieces 20 to overlap the lines (to accommodate imprecise placement by of the user), while still leaving significant portions of the lines visible so that user can continue to see the overall shape of the drawing 14, and for orientation purposes.

The cut pieces 20 can be adhered to the drawing 14 by any of a variety of manners. For example, in one case a glue or adhesive (i.e. liquid glue or a glue stick) may be utilized. Alternately, each assembly sheet 12/drawing 14 may be a two-ply sheet having an adhesive portion 15 and a release liner 17 carried thereon. The release liner 17 may be made of paper or the other materials described above for the assembly sheet 12. The assembly sheet 12 may be “kiss-cut” along line 19 (i.e. the release liner 17 may be cut, but the adhesive portion 15 is not). The cut line 19 may extend, for example, around the drawing 14 or parts thereof. In FIG. 1-3, the cut line 19 extends around the trunk and leaves of the tree, and across its base.

In this case, as shown in FIG. 2, the tree-shaped portion of the release liner 17 can be peeled away, exposing the underlying adhesive portion 15. The cut pieces 20 can then be stuck onto the adhesive portion 15. This adhering step further enhances the fine motor skills of the user. The peelable portions 22 of the drawings 14 (i.e. a generally closed shape defined by a cut line 19) may include indicia located thereon (i.e. “peel here,” “peel it” or the like) to cue a user that that portion of the drawing 14 can be peeled away to expose the adhesive portion 15.

In another embodiment, the strips of color paper 16 may have a pressure-sensitive adhesive positioned on one side thereof, and a release liner may be positioned over the pressure-sensitive adhesive. In this manner, in order to adhere the cut pieces 20 onto the drawing 14, the release liner is first removed, and the cut pieces 20 are then placed onto the drawing 14.

The drawing 14 and/or strips of color paper 16 may be sized such that once the strips 16 are cut into square pieces 20 and adhered in place the cut pieces 20 generally fully cover/fill the associated drawing portion. In some cases the surface area of the strip of color paper 16 may be roughly equal to the surface area of the associated portion of the drawing 14. This feature allows a user to gauge relative progression of each task and to space the cut pieces 20 accordingly.

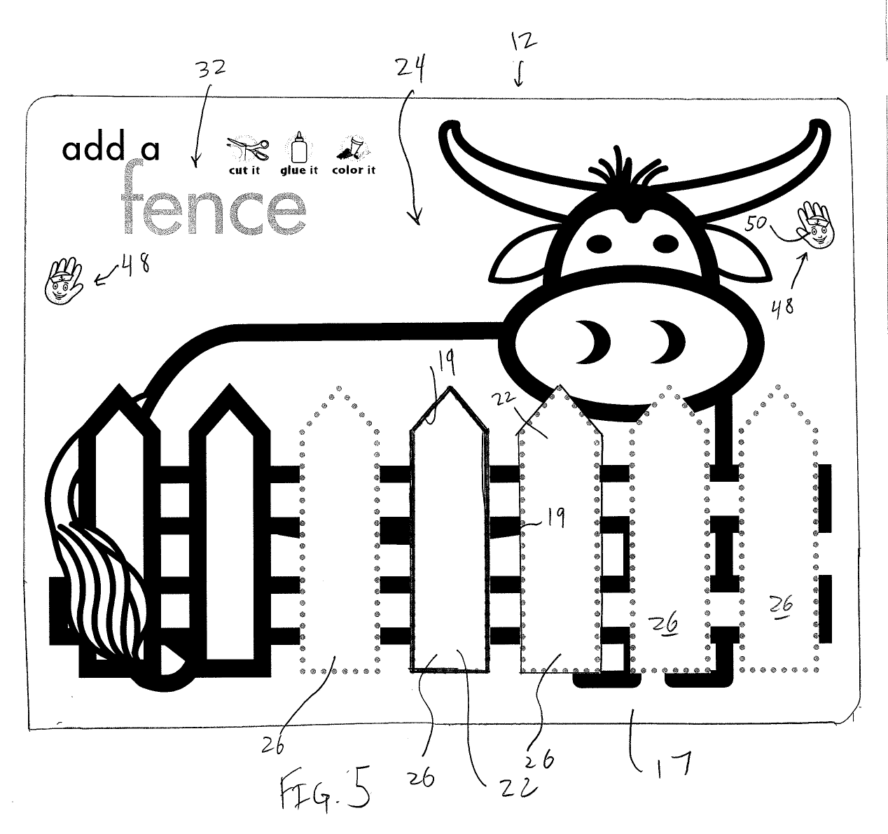

Rather than utilizing the two strips 16a, 16b of FIG. 1, only a single strip of 16 may be utilized, or more than two strips of 16 may be utilized. For example, FIG. 4 illustrates a drawing 14 of a rainbow with three discrete portions taking the form of three different stripes of the rainbow, with each stripe/discrete portion receiving a cut pieces 20 of a differing color therein.

The various component of each kit may be packaged for sale along with a set of instructions that instruct a user (or a user's parents, teachers, etc.) to use the components of the kit 10 in the manner described herein. The instructions can be textual, or pictorial, or a combination thereof. The strips of color paper 16, assembly sheet(s) 12, instructions, and optionally an adhesive and/or scissors, may be all packaged together for sale as a unit.

FIGS. 1-4 disclose embodiments wherein snipping skills (along with pasting or adhering skills) are developed. FIGS. 5-7 illustrate an embodiment wherein cutting skills are developed and may be utilized, for example, after snipping skills have been sufficiently mastered. In the embodiment of FIGS. 5-7, the drawing or the assembly sheet 12 includes an incomplete drawing or a drawing 24 with incomplete portions 26. The incomplete portions 26 are shown by dotted lines or thinned in the illustrated embodiment, although the incomplete portions 26 can be indicated by a variety of other means, such as dashed or incomplete lines, particular colors, lightened lines, thinned lines, areas of shading, combinations of these features, or the like. In the embodiment of FIG. 5 the incomplete portions 26 are pickets of a picket fence.

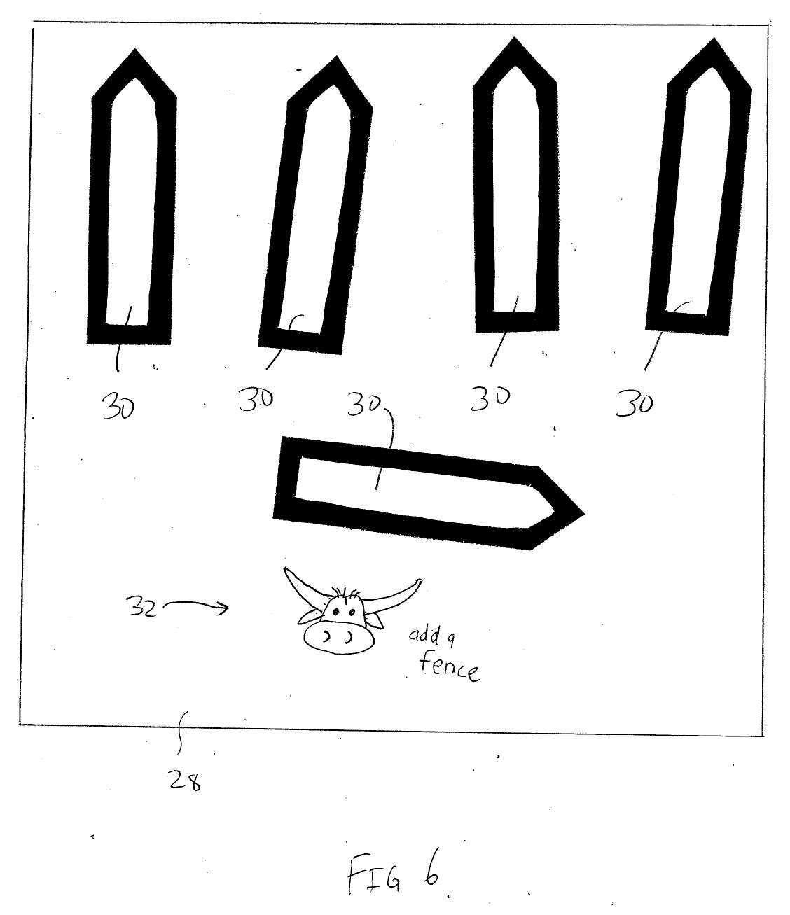

The assembly sheet 12 is coupled to or packaged with a cutting sheet 28 (FIG. 6) that includes drawing/cut pieces 30 of pickets that match in size and shape the incomplete portions 26 of the assembly sheet 12 of FIG. 5. The cut pieces 30 may be geometric shapes that are relatively easy to cut although if desired other shapes can be utilized. The sheets 12/28 may have indicia 32 (in this case, the text “add a fence” and the drawing of a cow) that communicate a connection between the drawings 24 of the sheets 10/12 and the drawings 30 of the cutting sheet 28. In this case, a user is encourage or instructed to cut out the picket shapes 30 of FIG. 6 and adhere them onto the incomplete portions 26 of the fence of FIG. 5. For example, FIG. 7 illustrates a cut picket 30 from the sheet 28 of FIG. 6 adhered to the drawing 24 of FIG. 5. The cutting sheet 28/cut shapes 30 may be made of colored paper that matches the expected color of that component (i.e. white or brown pickets), or can be made of a more whimsical, decorative color (i.e. purple).

The lines defining the cut pieces 20 may be relatively thick (i.e. in one embodiment having a thickness of at least about ⅛ inch, or between about ⅛ inch and about ¼ inch thick.) These thickness of the lines of the cut pieces 20 helps to accommodate users with developing scissor skills so that the user can deviate a bit but still remain within the thick lines, which increases cutting success and confidence. The lines defining the drawing 14 and cut pieces 20 may also provide a high contrast between the underlying sheet material to allow easily identification of the drawings 14 and cut pieces 20, and to provide guidance to the user. For example, the lines defining the drawing 14 and cut pieces 20 may be black, and the underlying sheet material can be white or other colors.

The cut shapes 30 of the sheet 28 can be adhered to the assembly sheet 12 by any of the methods described above in the embodiments of FIGS. 1-4. For example, each incomplete shape 26 may include a cut line 19 extending therearound which defines a peelable portion 22 (see peelable portion 22 of FIG. 7 that is partially peeled) that can be removed from the incomplete shape 26. Alternately, the incomplete shapes 26 may not be peelable and the cut shape 30 can be adhered thereto by an adhesive such as glue, or an adhesive on the cut shapes 30.

Various assembly sheets 12/cutting sheet 28 of the embodiment of FIGS. 5-7 can be bound together, and can be bound with the sheets 12 of the embodiment of FIGS. 1-4. The various assembly sheets 12/cutting sheets 28 may provide progressively more complex cut shapes 30 to progressive challenge and improve the cutting skills of a user. Moreover, the cutting sheets 28 (i.e. the sheet 28 of FIG. 6) may include the strips 16 of the embodiment of FIGS. 1-4 integrated therein. For example, when the strips 16 are colored, and the cut shapes 30 are of the color, the strips 16 and cut shapes 30 can be drawn/defined on a single colored sheet 28 to save space and provide paper efficiency.

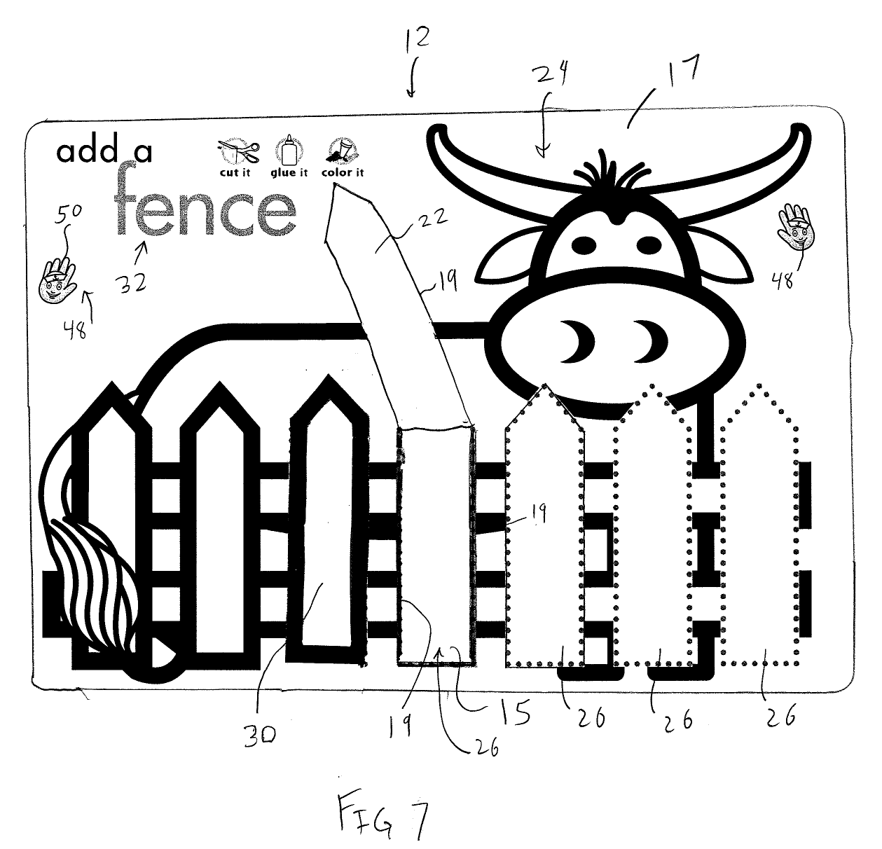

The embodiment of FIGS. 5-7 teaches cutting and placing/pasting skills wherein the cut shapes 30 are placed within a defined boundary 26. In the embodiment of FIGS. 8 and 9, more developed skills are required/developed. In particular, the cut sheet 30 of FIG. 9 includes various cut portions 30 that correspond in size and shape to the incomplete portions 26 of the assembly sheet 12 of FIG. 8. In this case, the cut shapes 30 of FIG. 9 can be cut out of the sheet 30 and arranged immediately adjacent to each other on the assembly sheet 12 to form the desired shape/designs. Since the cut shapes 30 must be placed immediately adjacent to each other, the embodiment of FIGS. 8 and 9 requires more precise placement of the cut shapes 30 and therefore develops manual dexterity and visual perception skills of the user.

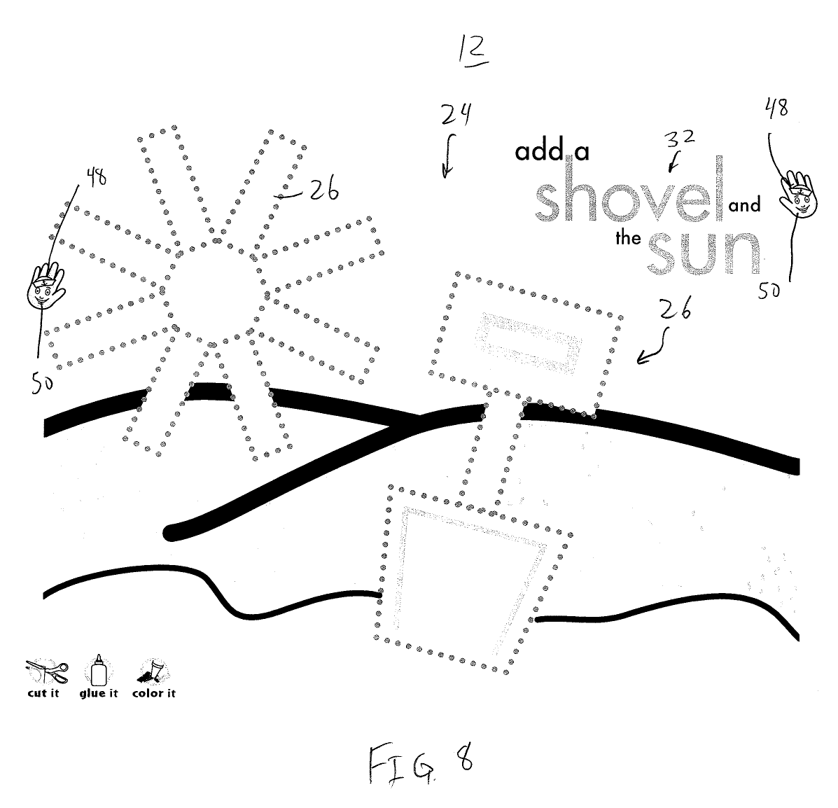

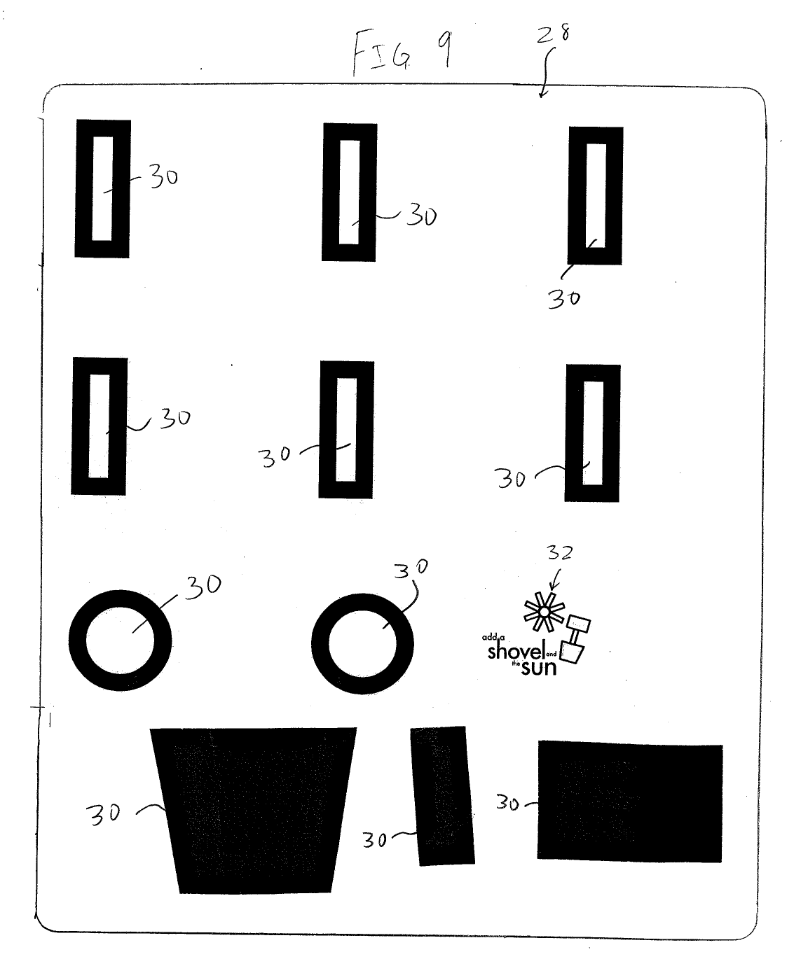

While the embodiment of FIGS. 8 and 9 requires the user to arrange and adhere adjacent shapes 30, the assembly sheet 12 of FIG. 8 still provides guidance in the form of incomplete shape(s) 26 to guide a user's placement of the cut shapes 30. In the embodiment of FIGS. 10 and 11, the assembly sheet 12 provides no, or very little, direct guidance as to where the cut shapes 30 should be placed. For example, FIG. 10 illustrates an assembly sheet 12 with a small version 36 of the end assembly to be formed using the cut pieces 30 of the cutting sheet 28 of FIG. 11. A guide portion 38, in the form of the head of a caterpillar that corresponds to a cut portion 30, is included to provide a starting point for assembly, although the guide portion 38 can be omitted. Thus this embodiment of FIGS. 10 and 11 requires a higher degree of dexterity, motor planning, part-to-whole recognition, coordination and spatial recognition than the embodiment of FIGS. 8 and 9. Thus, a single bound assembly can provide progressively more challenging cutting/assembly tasks.

A bound assembly of the assembly sheets/cutting sheets can be arranged in a variety of manners. However, in one embodiment all of the assembly sheets and grouped together (i.e. in the front of the bound assembly) in a progressively more challenging manner. All of the cutting sheets can be grouped together (i.e. in the back of the bound assembly). Indicia 32 or the like may be used to connote a connection between the assembly sheets and the associated cut shapes. As suggested above, the cut shapes for a single assembly sheet can be spread across multiple cutting sheets, which provide paper efficiency. Moreover, spreading the cut shapes across multiple cutting sheets presents more challenge to the user and developing identification and recognition skills.

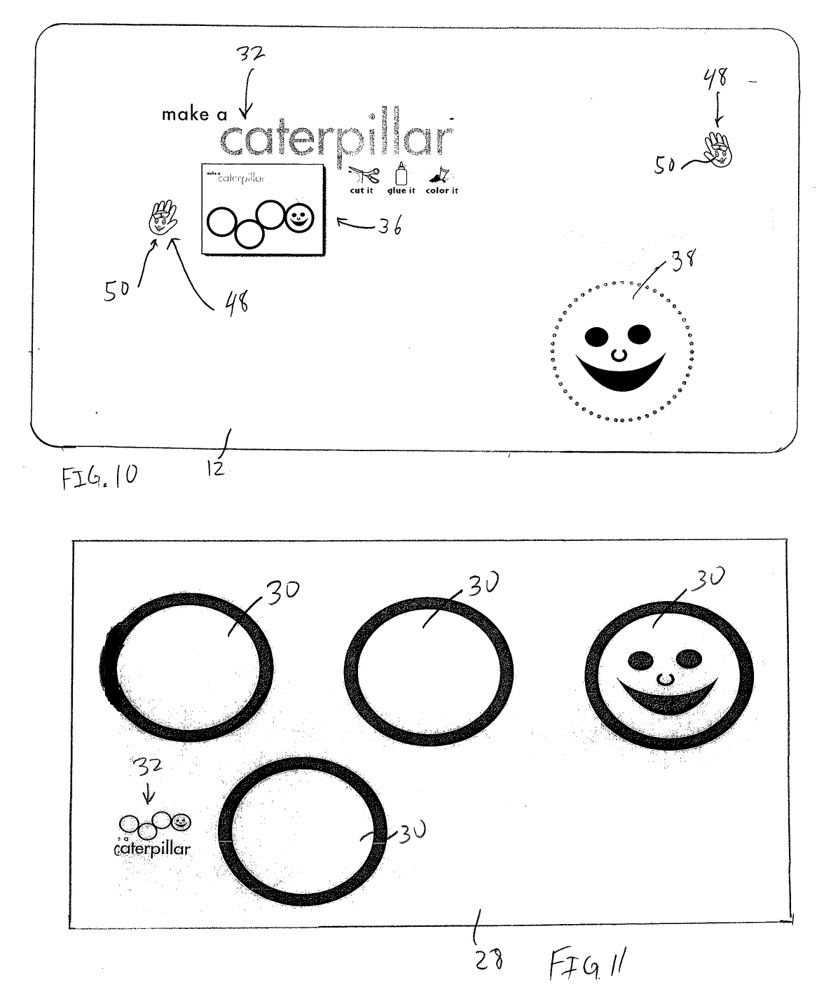

In the embodiment of FIGS. 12-14, two cutting sheets 28 are provided. The instructions may instruct a user to cut each cutting sheet 28 along the outer edge of its lines/cut pieces 30 resulting in the cut pieces 30 shown in FIG. 13. The instructions may then instruct the user to assemble the cut pieces 30 into a particular shape. For example, as shown in FIG. 14 the cut pieces 30 of FIG. 13 can be formed in an assembled shape 42 taking the form of a person, with the various cuts pieces 30 forming the person's limbs and torso, head, and hair.

In some cases the cut pieces may be provided with various indicia. For example, in the embodiment of FIGS. 10 and 11 and the embodiment of FIGS. 12-14, the “head” piece 30 includes a face pre-printed thereon. The pre-printed indicia may aid a user in assembly the cut pieces 30 in the proper manner. Alternately, the user may be instructed to draw indicia on the completed assembly. For example, the head piece may be blank, and the user may be instructed to draw a face thereon to develop the drawing skills of the user. In other cases, a user may be instructed to draw patterns, or other decorative features on or adjacent to the assembled shape.

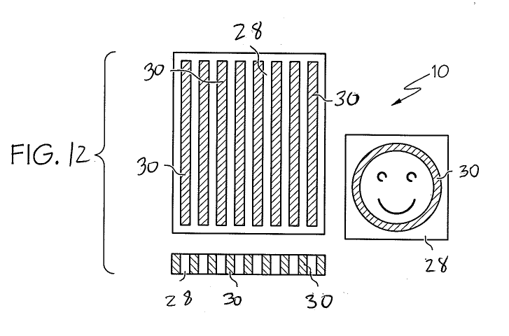

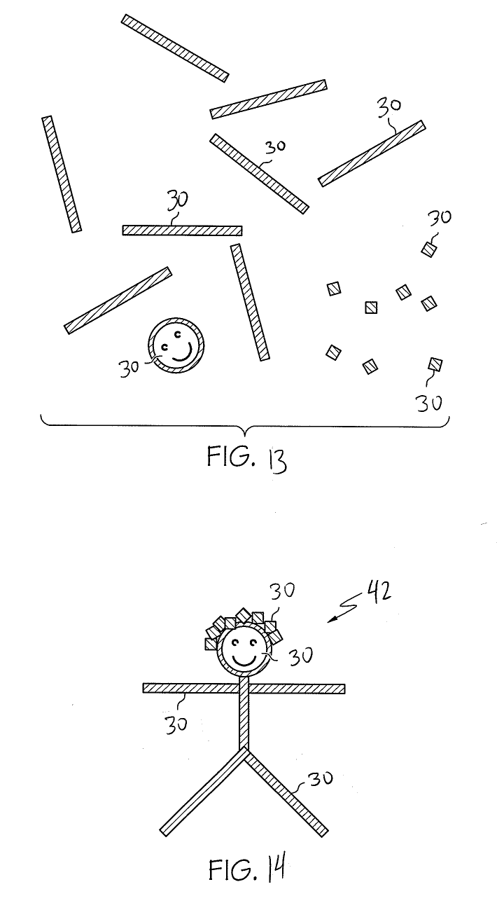

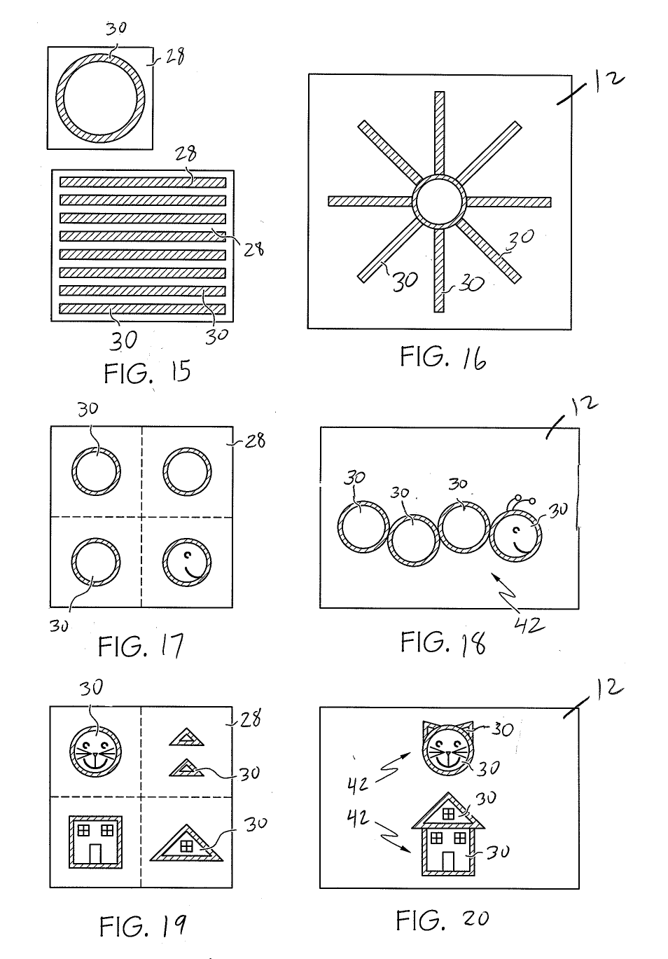

FIG. 15 illustrates another embodiment wherein two pieces of cutting sheets 28 are provided. The cutting sheets 28 can be cut along the outer edge of the cut shapes 30, and the cut shapes 30 can be assembled on an assembly sheet 12 to provide the “sun” shape shown in FIG. 16. The embodiment of FIGS. 17 and 18 illustrates a single cutting sheet 28 which can be cut along its cut shapes 30 to provide pieces 30 that can be arranged to form single assembled shape 42, and the embodiment of FIGS. 19 and 20 illustrates a single cutting sheet 28 which can be cut to provide cut shapes 30 that can be arranged to form two assembled shapes 42.

As shown in FIGS. 1, 5, 7, 8 and 10, the assembly sheet 12 (and optionally the cutting sheets 30) may include or carry thereon at least one hand cue 48 upon which a user can place his or her hand to manually stabilize the sheet 12 during use. Each hand cue 48 may include or take the form of a visual cue 50. In the illustrated embodiment, the visual cue 50 takes the form of a visual representation (i.e. drawing, design, photograph or the like) of a hand to cue or encourage a user to place his or her hand on the hand cue 48. However, the visual cue 50 can take the form of other indicia besides a hand. For example some other indicia 50 (by way of example, a star, or the letter “H,” although nearly any sort of indicia can be used) may be provided on the assembly sheet 12. A user may be taught (i.e. by the assembly sheet 12, associated instructions/packaging, by a teacher or parent, etc.) that the indicia 50 is to be associated with hand stabilization. In this case, when a user sees the visual cue 50 the user is prompted to stabilize the assembly sheet 12 with his or her non-dominant (i.e. non-writing) hand.

Teachers typically have difficulty ensuring that their students properly stabilize their assembly sheets 12 during use. Accordingly, the hand cues 48 serve as a constant reminder to the user to encourage proper stabilization and use of the assembly sheet 12.

Each hand cue 48 may be positioned at or adjacent to the outer perimeter of the assembly sheet 12 to ensure proper hand placement. In particular, encouraging a user to place his or her stabilization hand at or adjacent to the outer edge of the assembly sheet 12 ensures that maximum stabilization force is exerted while ensuring that the stabilization hand does not interfere with writing/drawing/cutting/pasting operations. Thus, at least part of each hand cue 48 may be located within about 3 inches of the outer edge of the assembly sheet 12, or within about 10% or 20% of the height or width of the assembly sheet 12 of the outer edge.

The assembly sheet 12 may include a hand cue 48 on both the left and right sides of the assembly sheet 12 (with the “left” and “right” orientation being taken from the perspective of a user viewing an assembly sheet as shown in the figures.) The use of two opposed hand cues 48 ensures that a hand cue 48 is sufficiently presented and available for both left-handed and right-handed users. Both hand cues 48 may be located in the upper half of the assembly sheet 12 since stabilization in the upper half of the sheet 12 is most effective and allows full access to the assembly sheet. Moreover, the hand cue 48 on the left side of the sheet 12 (utilized by right-handed users) is positioned below the hand cue 48 on the right side of the sheet 12 (utilized by left-handed users) (not shown in FIG. 1). Due to the layout of most drawing and assembly sheets, as well as orientation of writing desks, etc. it is desired to place the hand cue 48 for left-handed users higher on the sheet 12 than the other hand cue 48. In particular, due the differing ways in which a left-handed user typically positions and stabilizes paper compared to a right-handed user, the right cue 48 is optimally positioned higher on the sheet 12.

All of the various embodiment disclosed herein can be packaged/bound together into a single assembly/bound component. In this manner a user can progress through the various, and more advanced, embodiments as the user's skills develop. Moreover, as noted above, the various cut pieces 30 associated with the various different assembly sheets, and associated with the differing embodiment, can be arranged on a single or various combined cutting sheets.

Thus the cutting system encourages a user to develop scissor skills, visual motor control skills (eye-hand coordination), visual perception skills (by recognizing and assembling shapes and drawings), visual spatial relationship skills (by determining the orientation of the pieces), bilateral coordination (by using both hands), motor planning (the ability to plan, sequence, and then place shapes) and visual closure (determining where to add the next cut piece to form the completed picture).

Having described the invention in detail and by reference to the various embodiments, it should be understood that modifications and variations thereof are possible without departing from the scope of the invention.

What is claimed is:

1. An activity kit comprising:
an assembly sheet with a drawing provided thereon;
a strip of color paper; and
instructions instructing a user to cut said strip of color paper into smaller pieces and adhere said cut pieces onto said drawing.

2. The activity kit of claim 1 wherein said assembly sheet is a two-ply sheet having an adhesive portion and a release liner portion.

3. The activity kit of claim 2 wherein said assembly sheet includes a cut line which generally extends through said release liner portion but not said adhesive portion, and wherein said cut line generally conforms to at least part of said drawing such that part of said release liner portion is separable away from said adhesive portion along said cut line to expose said adhesive portion such that cut pieces are aherable to said exposed adhesive portion.

4. The activity kit of claim 3 wherein said cut line defines a generally closed shape in said release liner portion that is peelable away from said adhesive portion, and wherein said assembly sheet includes indicia positioned on said generally closed shape indicating the peelable nature thereof.

5. The activity kit of claim 1 wherein said drawing is defined by a line having thickness of at least about ⅛ inch.

6. The activity kit of claim 1 wherein said strip of color paper is of a color matching the typical color of part of said drawing.

7. The activity kit of claim 6 wherein said instructions instruct said user to adhere said cut pieces onto said part of said drawing typically having a color matching said cut pieces.

8. The activity kit of claim 1 further comprising a supplemental strip of color paper of a different color than said strip of color paper, and wherein said instructions instruct a user to cut said supplemental strip of color paper into smaller pieces, and wherein said instructions instruct a user to adhere said cut pieces of said strip of color paper onto a part of said drawing typically having a color matching said color of said strip of color paper, and wherein said instructions instruct a user to adhere said cut pieces of said supplemental strip of color paper onto a part of said drawing typically having a color matching said color of said supplemental strip of color paper.

9. The activity kit of claim 1 wherein said strip of color paper has a length longer than its width, and wherein said width is less than about 1½ inches to allow easy snipping thereof.

10. The activity kit of claim 1 wherein said strip of color paper has a surface area roughly equal to a surface area of a discrete portion of said drawing.

11. The activity kit of claim 1 wherein said assembly sheet has a height and a width, and wherein said strip of color paper has a length about equal said height or said width of said assembly sheet.

12. The activity kit of claim 1 wherein said assembly sheet, said strip of color paper and said instructions are all packaged together for sale as a single unit.

13. The activity kit of claim 1 wherein said instructions instruct a user to cut said strip of color paper with a single snip.

14. The activity kit of claim 1 further comprising a plurality of pieces of cutting sheets with lines carried thereon, wherein said instructions instruct a user to cut each cutting sheet along its lines and assemble the cut pieces into a particular shape.

15. The activity kit of claim 1 further comprising a plurality of pieces of cutting sheets with lines carried thereon, wherein said instructions instruct a user to cut each cutting sheet along its lines and adhere pieces cut from said cut sheet onto an assembly sheet that is coupled to said assembly sheet.

16. The activity kit of claim 1 wherein said strip of color paper is integrated into a larger sheet.

17. The activity kit of claim 16 wherein said strip of color paper has a clear boundary defining said strip of color paper from the rest of said larger sheet.

18. The activity kit of claim 17 wherein said instructions instruct a user to cut said larger sheet along said clear boundary to separate said strip of color paper from the rest of said larger sheet.

19. The activity kit of claim 1 wherein said instructions are textual, or pictorial, or a combination thereof.

20. A method for creating a craft project comprising:
accessing an activity kit including an assembly sheet with a drawing provided thereon and a strip of color paper;
cutting said strip of color paper into smaller pieces; and
adhering said cut pieces onto said drawing.

21. The method of claim 20 wherein, before said accessing step, said assembly sheet and strip of color paper are packaged together for sale as a unit.

22. The method of claim 20 wherein said activity kit includes instructions instructing a user to cut said strip of color paper into smaller piece and adhere said cut pieces onto said drawing.

23. The method of claim 20 wherein said strip of color paper is of a color matching the typical color of part of said drawing, and said adhering step includes adhering said cut pieces to said part of said drawing.

24. The method of claim 23 wherein said activity kit further includes a supplemental strip of color paper of a different color than said strip of color paper, and wherein said cutting step includes cutting said supplemental strip of color paper into smaller pieces, and wherein said supplemental strip of color paper is of a color matching the typical color of part of said drawing, and said adhering step includes adhering said cut pieces of said supplemental strip of color paper to the matching color part of said drawing.

25. The method of claim 20 wherein said strip of color paper is integrated into a larger sheet, and wherein the method further includes the step of cutting said strip of color paper out of said larger sheet.
